(19) United States
(12) Patent Application Publication
(10) Pub. No.: US 2017/0286338 A1
(43) Pub. Date: Oct. 5, 2017

(54) METHODS AND APPARATUS FOR COMBINING MULTIPLE, CODEPENDENT, MEDIA AGNOSTIC USB OPERATIONS

(71) Applicant: Intel Corporation, Santa Clara, CA (US)

(72) Inventors: Maciej Kurczewski, Gdansk (PL); Rafal Wielicki, Gdansk (PL)

(21) Appl. No.: 15/087,602

(22) Filed: Mar. 31, 2016

(51) Int. Cl. G06F 13/36; G06F 13/42

(52) U.S. Cl. CPC G06F 13/36; G06F 13/4282; G06F 2213/0042

(57) ABSTRACT

Methods and apparatus to combine multiple codependent media agnostic USB operations are disclosed. An example method includes receiving a transmission from a USB device driver, determining a plurality of requests associated with the received transmission, bundling the plurality of requests into a single request, and transmitting the single request to a USB device.

### FIELD OF THE DISCLOSURE

This disclosure relates generally to universal serial bus and, more particularly, to methods and apparatus for combining multiple, codependent, media agnostic universal serial buses operations.

### BACKGROUND

A Media Agnostic Universal Serial Bus (USB) is used to wirelessly connect an electronic device to other electronic devices to facilitate wireless communication between the electronic devices using USB communication protocols via a variety of different media types (e.g., through a number of different communication technologies/protocols) including wired links (e.g., Ethernet links), WiMedia ultra-wide band links, Wi-Fi links, Wireless Gigabit Alliance (WiGig) links, and/or any other type of wireless links. Using Media Agnostic USB technology, a USB device driver can communicate (e.g., transmit requests and receive response) with a Media Agnostic USB device driver via a variety of different media types.

### BRIEF DESCRIPTION OF THE DRAWINGS

FIG. 1 is an example illustration of a system to facilitate wireless communications between an example computing device and an example electronic device.

FIG. 2 is an example illustration of a system to facilitate wireless communications between an example Universal Serial Bus device and an example Media Agnostic Universal Serial Bus endpoint.

FIG. 3 is a block diagram of an example of the Media Agnostic Universal Serial Bus host protocol adaptation layer of FIG. 2.

FIG. 4 is a block diagram of an example of the Media Agnostic Universal Serial Bus device protocol adaptation layer of FIG. 2.

FIG. 5 is a flowchart representative of example machine readable instructions that may be executed to implement the example Media Agnostic Universal Serial Bus host protocol adaptation layer of FIG. 3.

FIG. 6 is a flowchart representative of example machine readable instructions that may be executed to implement the example Media Agnostic Universal Serial Bus device protocol adaptation layer of FIG. 4.

FIG. 7 is a diagram representative of example communication between the example Universal Serial Bus device, the example Media Agnostic Universal Serial Bus host, the example Media Agnostic Universal Serial Bus device, and the example Media Agnostic Universal Serial Bus endpoint of FIG. 2.

FIG. 8 is a block diagram of a processor platform structured to execute the example machine readable instructions of FIG. 5 to implement the example Media Agnostic Universal Serial Bus host protocol adaptation layer of FIG. 3.

FIG. 9 is a block diagram of a processor platform structured to execute the example machine readable instructions of FIG. 6 to implement the example Media Agnostic Universal Serial Bus device protocol adaptation layer of FIG. 4.

The figures are not to scale. Wherever possible, the same reference numbers will be used throughout the drawing(s) and accompanying written description to refer to the same or like parts.

### DETAILED DESCRIPTION

Media Agnostic Universal Serial Bus (MA-USB) Protocol Adaption Layer (PAL) enables communication of Universal Serial Bus (USB) data between two or more electronic devices over media other than a USB cable. For example, MA-USB PAL can communicate data over wireless (e.g., Wi-Fi, Wireless Gigabit Alliance (WiGig), etc.) links or wired (e.g., Ethernet) links. MA-USB PALs allow devices to directly interface with each other using a media access control (MAC) layer (e.g., 802.11a/b/n/av/ad, 802.3) or Internet Protocol (IP) applications (e.g. Transmission Control Protocol (TCP)/IP stacks).

A computing device may include a USB device driver and a MA-USB host to wirelessly communicate USB data with one or more MA-USB devices (e.g., a mouse, a digital camera, a printer, a cellphone, etc.) via an MA-USB PAL. The USB device driver may, for example, transmit a request, via the MA-USB host PAL, to an MA-USB endpoint of a MA-USB device to execute a particular command. Each MA-USB device includes one or more MA-USB endpoints for one or more functionalities. For example, if the MA-USB device is a multipurpose printing device, a first endpoint may be associated with printing while a second endpoint may be associated with scanning. In such an example, the USB device driver may send a request associated with an operation to the first endpoint of the MA-USB device, the second endpoint of the MA-USB device, or both.

When a transmission error occurs on a MA-USB endpoint, the USB device driver may react to the error by transmitting transmissions to the MA-USB endpoint of an MA-USB device to perform a specific operation (e.g., an abort operation, a state change, etc.). A suspend operation and/or an abort operation involves a plurality of sequential requests to be transmitted to the MA-USB device. The MA-USB device, equipped with the sequential requests, sequentially transmits commands (e.g., associated with the requests) to the MA-USB endpoint. In some examples, an MA-USB device includes child devices. In such examples, the MA-USB device may include a hierarchy of the child devices. In some examples, an operation (e.g., such as a suspend operation) can only be performed on the MA-USB device once the operation has been performed on the child devices.

A USB device driver may send a transmission (e.g., a signal) associated with an operation (e.g., suspend, abort, state change, etc.) to an MA-USB host to relay a plurality of sequential requests associated with the operation to an MA-USB device. The MA-USB device receives the plurality of sequential requests and sequentially transmits endpoint commands associated with the sequential requests to the USB endpoint. In some examples, the USB endpoint transmits a response to the MA-USB device after an endpoint command has been received by the USB endpoint. The MA-USB device transmits one or more responses to the MA-USB host after the commands have been received and/or executed. In response to the MA-USB host receiving the all of the one or more responses, the MA-USB host sends a completed response indicating that the plurality of commands associated with the transmission sent by the USB device driver has been executed.

In conventional MA-USB protocol, the MA-USB host transmits each request of the sequential request to the MA-USB device separately, in sequential order. For example, the sequential request may include first and second requests. In such an example, the MA-USB host transmits the first request to the MA-USB device and waits for a response (e.g. a verification that the MA-USB device received the first request). If a threshold amount of time has lapsed since the request was transmitted, the MA-USB host will re-transmit the first request to the MA-USB device.

Once the MA-USB device receives the first request, the MA-USB device transmits a first command associated with the first request to an MA-USB endpoint. In some examples, the MA-USB device waits to receive a response from the MA-USB endpoint verifying that the first command was received and/or executed. After the MA-USB device transmits the first command to the MA-USB endpoint (or after the MA-USB device receives the first command response), the MA-USB device sends a first request response to the MA-USB host. The duration of time between when the MA-USB hosts transmits the first request and the MA-USB host receives the first request response is herein referred to as a Round-Trip-Time (RTT).

Once the MA-USB host receives the first request response, the MA-USB host transmits a second request to the MA-USB device and the process is repeated for the second request. Thus, the latency for a sequential request including two request operations using conventional techniques is 2×RTT. Additionally, poor link conditions may lead to packet loss (e.g., where a request does not reach the MA-USB device). Thus, the MA-USB host re-transmits the request after a preset amount of timeout (e.g., delay) (e.g., 5 milliseconds) adding additional latency. If a response to a request has not been received by the MA-USB host, the MA-USB host repeats the transmission of the request to the MA-USB device. Using conventional techniques, the MA-USB device transmits the multiple requests separately, increasing the probability that at least one of the multiple requests will be lost. Request loss increases latency beyond 2×RTT.

Conventional USB protocols operate quickly over a physical medium (e.g., a USB cable). However, such conventional protocols include more latency (e.g., delay) when utilized on a wireless medium. Such increased latency may hinder user experience. For example, if an MA-USB device includes a hierarchy of child devices and an operation is not efficient due to increased delay, a large tree of child devices could significantly delay power transition of the entire hierarchy. Delayed power transition compromises power efficiency and causes slower performance. In some examples, increased latency in USB endpoints playing audio may create audible “glitches” in the audio.

Examples disclosed herein alleviate latency problems caused by conventional protocols by allowing an MA-USB host to bundle several sequential requests to be made to an MA-USB device into a single protocol exchange. By bundling the several requests, the latency is significantly decreased, and power consumption and performance are optimized. Using examples disclosed herein, the MA-USB host receives a transmission from a USB device driver, which in some examples, may identify an operation to be performed by an MA-USB endpoint. The MA-USB host determines two or more requests associated with the operation. As disclosed herein, the MA-USB host generates a single bundle request identifying the two or more requests. Put another way, the MA-USB host bundles the two or more requests into a single bundle request. The MA-USB host wirelessly transmits the single bundle request to an MA-USB device. The MA-USB device identifies the two or more requests from the single bundle request and sequentially transmits commands associated with the two or more requests to the MA-USB endpoint. Once all of the commands associated with the two or more requests have been executed by the MA-USB endpoint, the MA-USB device wirelessly transmits a bundle response to the MA-USB host identifying that the commands have been executed. Thus, the latency using examples disclosed herein is roughly 1×RTT (e.g., the latency associated with a single conventional request) regardless of the number of request in a bundle request. Thus, the latency associated with the conventional MA-USB protocol is reduced significantly. For example, the latency associated with conventional protocols in good link conditions depends on the number of requests (e.g., two requests requires 2×RTT, three requests requires 3×RTT, etc.), whereas the latency associated with a single bundle request (e.g., including any number of requests) is 1×RTT. Additionally, the probability of packet loss of examples disclosed herein is reduced because only one request is being transmitted (e.g., the bundle request).

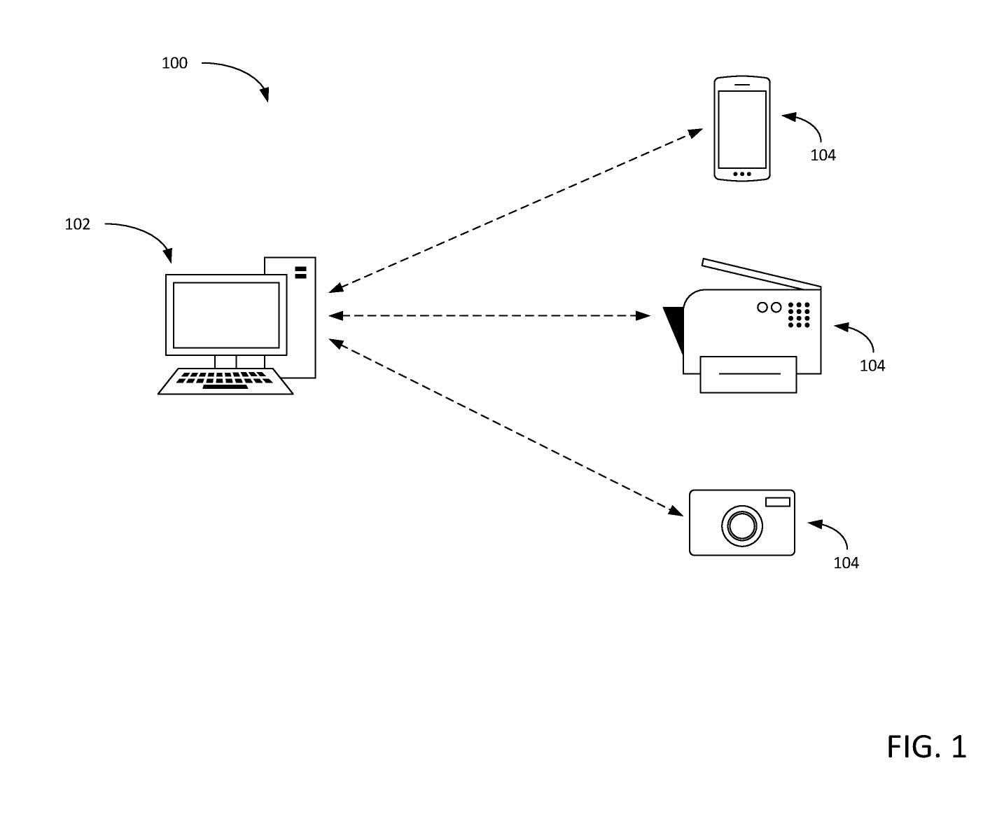

FIG. 1 is an example environment 100 illustrating a wireless USB connection between an example computing device 102 and example electronic devices 104. The example environment 100 serves as an example of methods and apparatus disclosed herein. Accordingly, the example computing device 102 may be any type of computing device incorporating a USB device driver and MA-USB host and the example electronic devices 104 may be any type of electronic device structured to wirelessly communicate USB data.

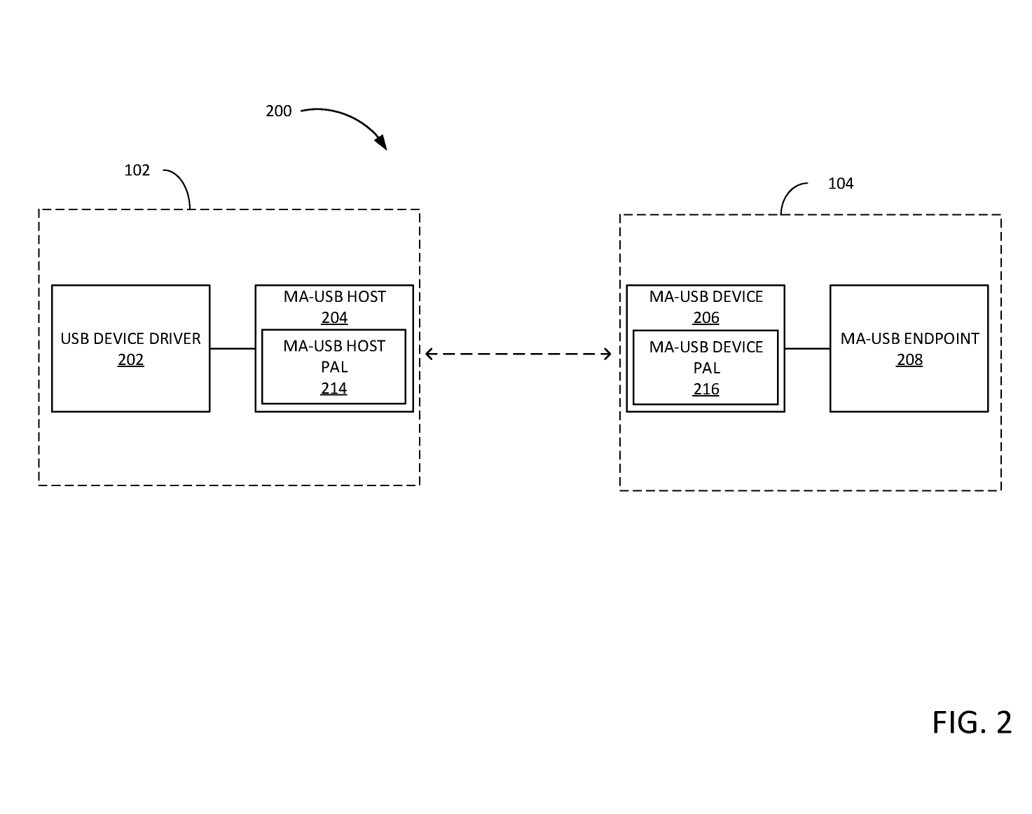

In the example environment 100, the example computing device 102 is a computer. Alternatively, the example computer device may be any computing device (e.g., a tablet, a mobile device, a portable computing device, a processor, a gaming system, a server, a gateway, and/or any computing device). The example computer device 102 includes a USB device driver and a MA-USB host. As further described in FIG. 2, the USB device driver communicates USB data to the example electronic devices 104 via the MA-USB host.

The example electronic devices 104 wirelessly communicate USB data. In the example environment 100, the example electronic devices 104 include a cellphone, a multipurpose printer, and a digital camera. Alternatively, the example electronic devices 104 may include any electronic device (e.g., a mouse, a keyboard, speakers, chip card devices, joysticks, trackpads, USB hubs, mass storage, etc.) that communicates USB data. The example electronic devices 104 include at least one MA-USB endpoint. Each MA-USB endpoint corresponds to a USB endpoint in the example electronic devices 104. Thus, the example electronic devices 104 may include any number of MA-USB endpoints. For example, the multipurpose printer may have a first MA-USB endpoint corresponding to a printing function, a second MA-USB endpoint corresponding to a scanning function, a third MA-USB endpoint corresponding to a faxing function, etc. In some examples, the example electronic devices 104 communicate to the example computing device 102 via a hub (e.g., a MA-USB hub). In such examples, the hub enables wireless communication of data between the example computing device 102 and the example electronic devices 104.

In operation, the MA-USB host of the example computing device 102 transmits USB data (e.g., an operation, a request, etc.) to one of the example electronic devices 104. The example electronic device 104 receives the transmitted USB data and transmits commands associated with the USB data to the endpoint(s) of the example electronic device 104. Once the commands have been executed, the electronic device 104 may transmit a response to the MA-USB host of the example computing device 102.

FIG. 2 is an example environment 200 illustrating communication between the example computing device 102 and one of the example electronic devices 104 of FIG. 1 via an MA-USB PAL. The example computing device 102 includes an example USB device driver 202 and an example MA-USB host 204. The example electronic device 104 includes an example MA-USB device 206 and an example MA-USB endpoint 208. The example MA-USB host 204 includes an example MA-USB host PAL 214 and the example MA-USB device 206 includes an example MA-USB device PAL 216.

The example USB device driver 202 may be implemented by hardware, software, and/or firmware to communicate USB data (e.g., as defined by a USB specification, such as the USB 2.0 or USB 3.0 specification) to MA-USB devices (e.g., via the example MA-USB host 204) over a network connection. For example, the example USB device driver 202 may be, for example, a computer, a mobile device, a server, a handheld device, a storage device, a memory device, a tablet, an electrical circuit, and/or any type of computing device. Alternatively, the example USB device driver 202 may be any type of wireless USB device driver.

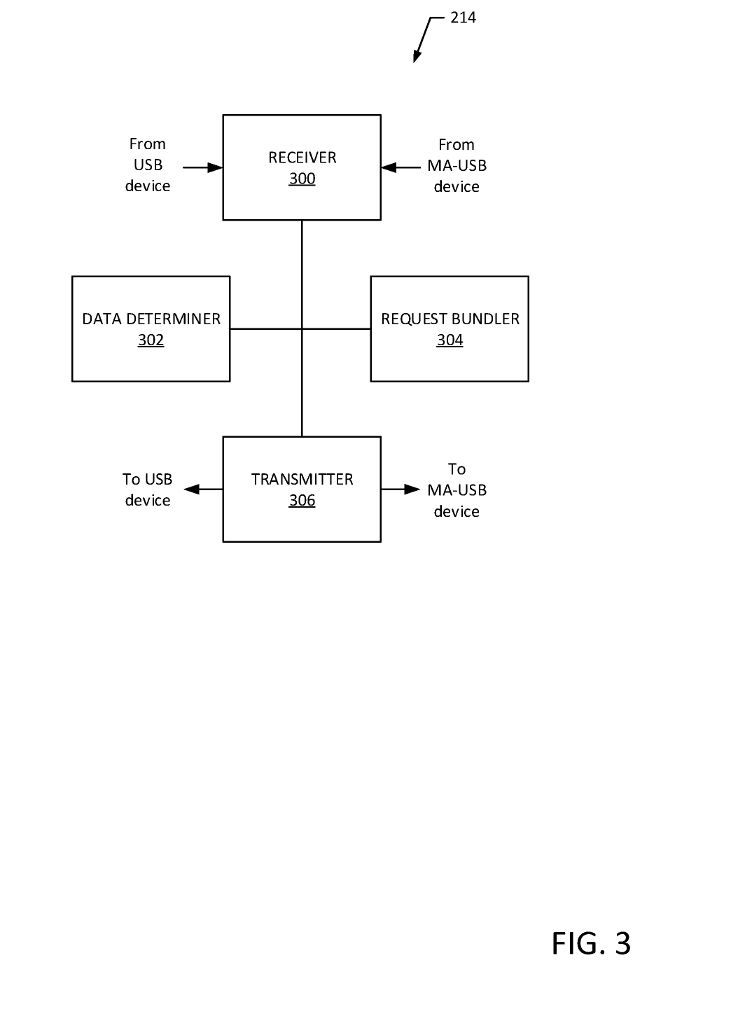

The example MA-USB host 204 includes one or more electrical devices to control communication between the example USB device driver 202 and the example MA-USB endpoint 208. For example, the MA-USB host 204 may be, for example, a computer, a mobile device, a server, a gateway, a handheld device, a storage device, a memory device, a tablet, an electrical circuit, and/or any type of computing device. As further described in FIG. 3, the example MA-USB host 204 includes the MA-USB host PAL 214 to wirelessly transmit a single bundle transmission (e.g. request) including a bundle of requests to the example MA-USB device 206. In some examples, the example MA-USB host 204 further includes a Media Access Controller (MAC) host PAL and/or a MAC device circuit to transmit the bundles to the example MA-USB device 206 via a MAC layer.

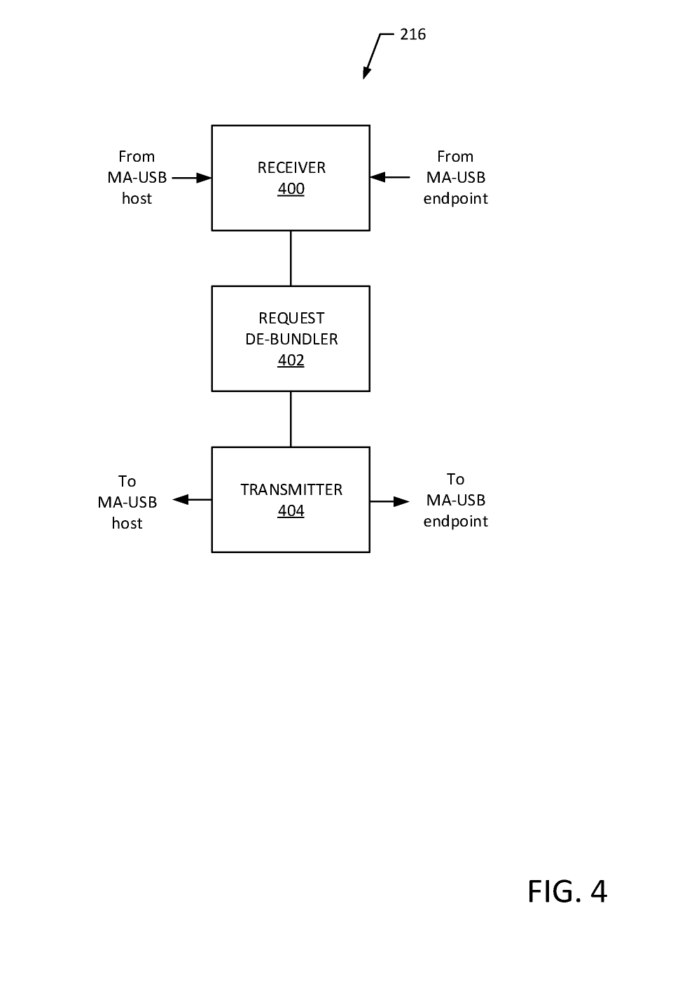

The example MA-USB device 206 is a device structured to communicate content, data, sigXXnals, requests, commands, response, etc. to the example MA-USB host 204 and/or the example MA-USB endpoint 208 over a communication medium via a PAL. The example MA-USB device 206 may be, for example, a mouse, a keyboard, a USB flash drive, a digital camera, a cell phone, a computer, an electrical circuit, and/or any type of electronic device. As further described in FIG. 4, the example MA-USB device 206 includes the MA-USB device PAL 216 to receive a bundle of requests (e.g., in a single bundle transmission) from the example MA-USB host 204 and transmit a sequential commands associated with the bundle of requests to the example MA-USB endpoint 208. The example MA-USB device PAL 216 further transmits a bundle response to the example MA-USB host 204 once the sequential commands have been executed.

The example MA-USB endpoint 208 receives commands from the example USB device driver 202 over a communication link. The MA-USB endpoint 208 may include a computer interface (e.g., an eXtensible Host Controller Interface). The computer interface may be any type of computer interface (e.g., Open Host Controller Interface, Universal Host Controller Interface, Enhanced Host Controller Interface, etc.). The example MA-USB endpoint 208 receives and executes the commands from the example MA-USB device 206. In some examples, the MA-USB endpoint 208 transmits a response corresponding to an executed command. Although the example electronic device 104 includes one MA-USB endpoint 208, the example electronic device 104 may include any number of MA-USB endpoints.

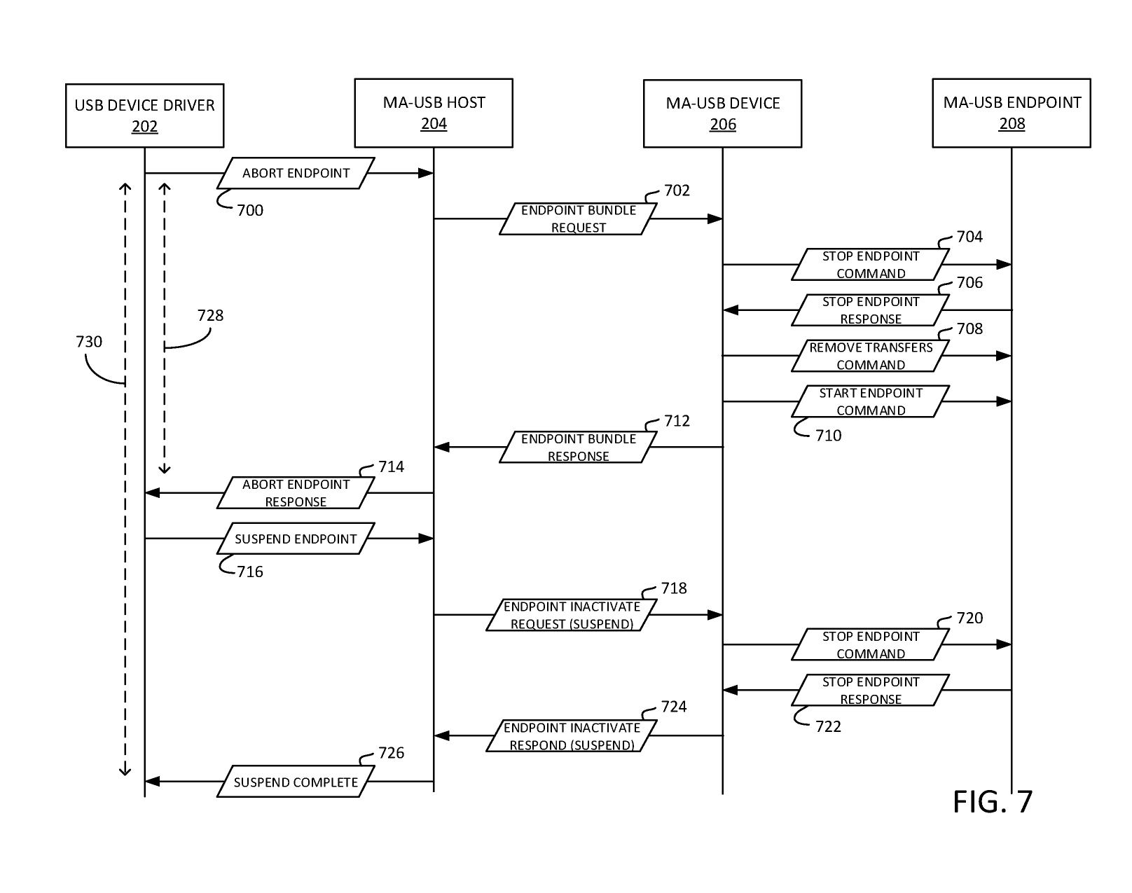

In operation, the example MA-USB host 204 transmits a transmission (e.g., wireless communication link and/or signal via a MAC layer) to the example MA-USB device 206. For example, if an error associated with the example MA-USB device driver 202 occurs, or the example MA-USB endpoint 208 is to be suspended, the example MA-USB host 204 may send a suspend and/or abort transmission to the example MA-USB device 206. The example transmission may be a WiFi link, a WiGig link, a WLAN link, or any other kind of IP link. The transmitted transmission identifies an operation to be performed by the example MA-USB endpoint 208. For example, the transmitted transmission may be a suspend device transmission. The suspend device transmission is a single transmitted to the example MA-USB endpoint 208 when the MA-USB endpoint 208 is change to an idle state (e.g., operating in low power). A suspend device transmission involves multiple operations including aborting and suspending the endpoint. In some examples, the USB device driver 202 sends the abort endpoint transmission first and, once a response has been received, sends a suspend transmission second. As further described in FIG. 7, the abort endpoint transmission includes multiple requests to be communicated between the example MA-USB host 204 and the example MA-USB device 206. The example MA USB host 204 receives the transmitted abort device transmission via a MAC layer.

The example MA-USB host PAL 214 processes the received transmission to determine a plurality of requests associated with the received transmission. For example, if the received transmission is an abort transmission, the requests may include an inactivate (e.g., stop endpoint) request, a clear endpoint transfers request, and/or an activate (e.g., start endpoint) request. The example MA-USB host PAL 214 bundles the requests and generates a single bundle request (e.g., transmission) including the bundled requests. In some examples, the MA-USB host PAL 214 includes an order identifier identifying an order of the requests in the single bundle request. The order identifier may be included to that the example MA USB device 206 can reorder the requests once the bundle is received. The example MA-USB host PAL 214 transmits the generated bundle request (e.g., via a MAC layer) to the example MA-USB device 206.

When the example MA-USB device 206 receives the bundle request (e.g., via a MAC layer), the example MA-USB device PAL 216 processes the bundle request to de-bundle the requests of the bundle request. As previously described, the bundle request may include a request order identifier. The example MA-USB device PAL 216 may analyze the bundle request to determine the request order. Alternatively, the MA-USB device PAL 216 may determine the order without an order identifier based on a request hierarchy. The example MA-USB controller 216 sequentially transmits a command for each request to the example MA-USB endpoint 208 to execute the commands. For example, the first command may be a stop endpoint command (e.g., associated with an endpoint inactivate request), the second command may be a remove transfers command (e.g., associated with an endpoint clear transfer request), and a third command may be start endpoint command (e.g., associated with an endpoint activate request). Thus, the example MA-USB controller 216 may transmit a stop endpoint command first, the remove transfers command second, and the start endpoint command last. In some examples, a command may require a response. For example, the stop endpoint command may require a stop endpoint response from the example MA-USB endpoint 208. In such an example, the example MA-USB may not send the subsequent commands until the inactivate response is received from example the MA-USB endpoint 208.

Once all of the commands associated with the bundle have been executed by the example MA-USB endpoint 208, the example MA-USB device PAL 216 transmits a bundle response to the example MA-USB host 204 (e.g., via a MAC layer). In response to receiving the bundle response, the example MA-USB host 204 transmits a response to the example USB device driver 202 identifying that the abort endpoint operation has been executed. In some examples, the USB device driver 202 may, in response to receiving the response, transmit a second transmission to the example MA-USB host 204 to suspend the example MA-USB endpoint 208, as further shown in FIG. 7.

FIG. 3 is a block diagram of an example implementation of the MA-USB host PAL 214 of FIG. 2, disclosed herein, to facilitate communications between the example USB device driver 202 and the example MA-USB device 206 of FIG. 2 by transmitting command bundles. While the example MA-USB host PAL 214 of FIG. 2 is described in conjunction with the example USB device driver 202 and the example MA-USB device 206, the example MA-USB host PAL 214 may be utilized to facilitate USB communications between any two USB devices. The example MA-USB host PAL 214 includes an example receiver 300, an example data determiner 302, an example request bundler 304, and an example transmitter 306.

The example receiver 300 receives transmissions from the example USB device driver 202 and the example MA-USB device 206. As described above, the transmission from the example USB device driver 202 corresponds to an operation (e.g., abort, suspend, switch states, etc.) to be performed by the MA-USB endpoint 208. The USB device transmission may identify the operation as well a corresponding endpoint. For example, the USB device transmission may identify that a particular endpoint (e.g., identified by an identifier) is to switch states to inactivate. In some examples, the USB device transmission may include a USB device identifier and/or other identifying data. The transmission from the example MA-USB device 206 is a bundle response. The bundle response corresponds to a verification that an operation has been executed by an MA-USB endpoint (e.g., the example MA-USB endpoint 208).

The example data determiner 302 processes received data from the example receiver 300. In some examples, the data determiner 302 determines an operation corresponding to the received transmission and identifies a USB endpoint based on the received transmission. For example, the data determiner 302 may determine that an abort operation is to be performed on the example USB endpoint 208 by processing a received transmission from the USB device driver 202. The example data determiner 302 may identify sequential requests associated with the determined operation. As described above, an operation may include a plurality of sequential requests. For example, an abort operation includes three requests (e.g., an inactivate request, a clear transfer request, and an activate request). In some examples, the data determiner 302 determines an order of the requests. Additionally, the example data determiner 302 may process received transmissions to determine MA-USB endpoint identifiers, MA-USB device identifiers, and/or USB device driver identifiers.

The example request bundler 304 generates a single bundle request by bundling the sequential requests into the single bundle request. In some examples, the request bundler 304 also includes USB device identifiers and/or an order of the requests. If the operation only requires one request, the example bundler 304 may determine that the request does not need to be bundled and instructs the example transmitter 306 to transmit the request without bundling.

The example transmitter 306 transmits the bundle requests generated by the example request bundler 304 to the example MA-USB device 206. As described above, the bundle requests may include bundled requests, an identifier associated with the USB device driver 202, and/or an order of the bundled requests. Additionally, the example transmitter 306 transmits response transmissions to the example USB device driver 202. As described above, the response transmission identifies that the operation sent from the example USB device driver 202 has been executed by the example MA-USB endpoint 208.

FIG. 4 is a block diagram of an example implementation of the MA-USB device PAL 216 of FIG. 2, disclosed herein, to facilitate communications between the example MA-USB host 204 and the example MA-USB endpoint 208 of FIG. 2 by de-bundling requests and transmitting the commands associated with the requests to the example MA-USB endpoint 208. While the example MA-USB host PAL 214 of FIG. 2 is described in conjunction with the example MA-USB host 204 and the example MA-USB endpoint 208, the example MA-USB device PAL 216 may be utilized to facilitate USB communications between any USB device driver and any MA-USB endpoint. The example MA-USB device PAL 216 includes an example receiver 400, an example request de-bundler 402, and an example transmitter 404.

The example receiver 400 receives transmissions from the example MA-USB host 204 and the example MA-USB endpoint 208. As described above, the transmission from the example MA-USB host 204 includes a bundle of requests associated with commands to be transmitted to the MA-USB endpoint 208. In some examples, the bundled requests may include a USB device driver identifier and/or a request order. The transmission from the example MA-USB endpoint 208 is a response to a command. As previously described, the example MA-USB endpoint 208 may transmit a transmission to the example MA-USB device 206 in response to receiving and/or executing a command. Thus, the command response corresponds to a verification that a command has been executed by the example MA-USB endpoint 208.

The example request de-bundler 402 processes a received bundle. The example request de-bundler 402 de-bundles the received bundle and identifies any other data (e.g., identifiers, an order, etc.) included in the bundle. In some examples, the request de-bundler 402 determines an order for the requests based on a received order. Alternatively, the request de-bundler 402 determines an order for the requests based on hierarchy of the requests. For example, a bundle may include an inactivate request, a clear transfers request, and an activate request. In such an example, a hierarchy of requests may identify that the inactivate request is first, the clear transfers request is second, and the activate request is third. Thus, the request de-bundler 402 may order the requests based on the hierarchy. Additionally, the request de-bundler 402 instructs the example transmitter 404 to transmit the commands associated with the requests sequentially associated with the requests according to the determined order. In some examples, the request de-bundler 402 does not instruct the example transmitter 404 to transmit a command until a response associated with a preceding command is received (e.g., via the example receiver 400).

The example transmitter 404 transmits the sequential commands to the example MA-USB endpoint 208 and transmits a bundle response to the example MA-USB device 206. In some examples, the example transmitter 404 transmits each of the sequential commands in order with a set delay between each command. In some examples, the example transmitter 404 transmits each of the sequential commands after the example receiver 400 receives a response from a preceding command. Additionally, the example transmitter 404 transmits a bundle response to the example MA-USB device 206 once all of the commands have been transmitted to the example MA-USB endpoint 208 and/or the appropriate command responses have been received from the example MA-USB endpoint 208.

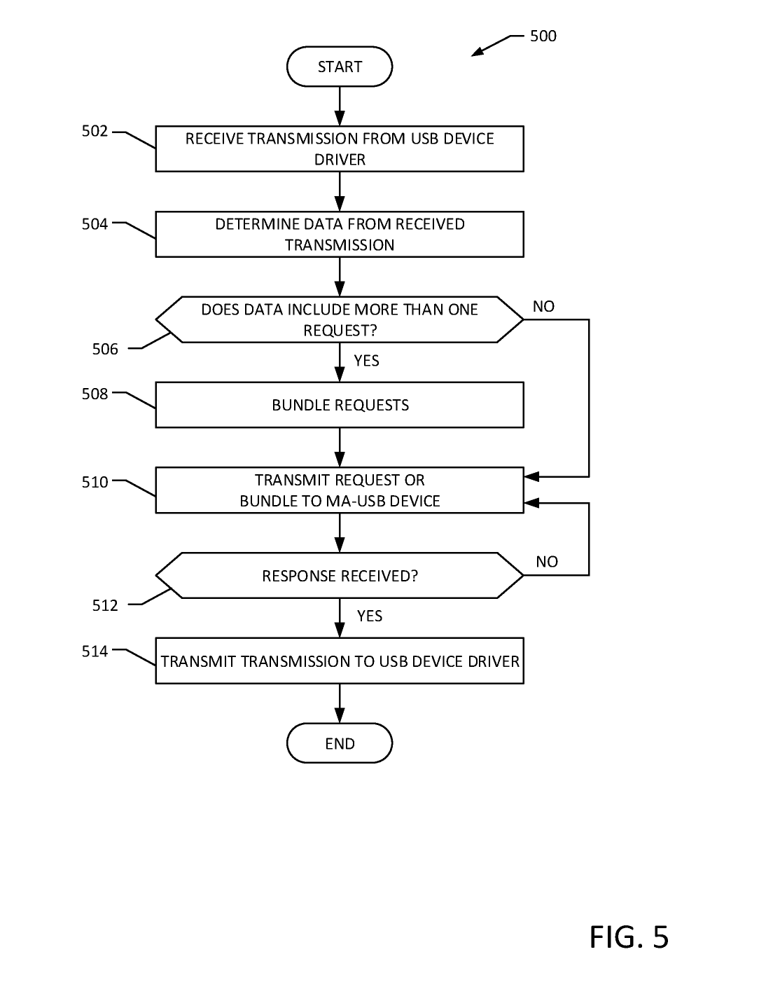

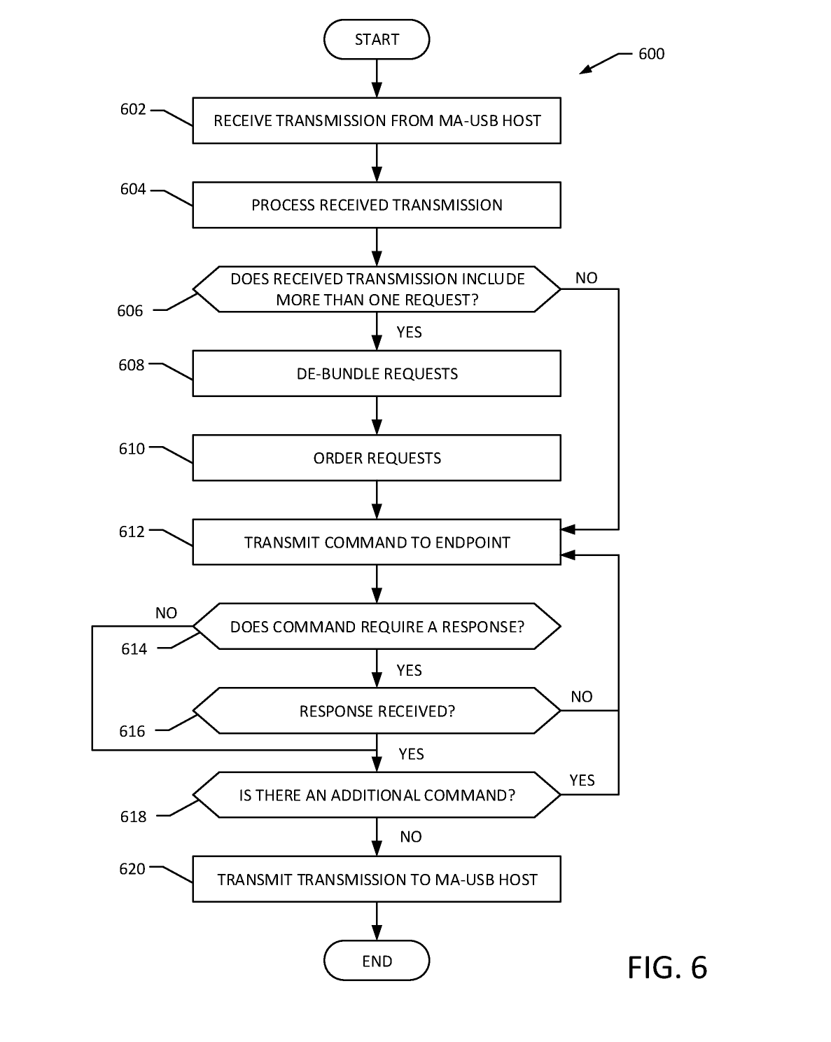

While example manners of implementing the example MA-USB host PAL 214 of FIG. 2 is illustrated in the FIG. 3 and the example MA-USB device PAL 216 of FIG. 2 is illustrated in FIG. 4, elements, processes and/or devices illustrated in FIGS. 3 and 4 may be combined, divided, re-arranged, omitted, eliminated and/or implemented in any other way. Further, the example receiver 300, the example data determiner 302, the example request bundler 304, the example transmitter 306 and/or, more generally, the example MA-USB host PAL 214 of FIG. 3, and/or the example receiver 400, the example request de-bundler 402, the example transmitter 404, and/or more generally, the example MA-USB device PAL 216 of FIG. 4 may be implemented by hardware, machine readable instructions, software, firmware and/or any combination of hardware, machine readable instructions, software and/or firmware. Thus, for example, any of the example receiver 300, the example data determiner 302, the example request bundler 304, the example transmitter 306 and/or, more generally, the example MA-USB host PAL 214 of FIG. 3, and/or the example receiver 400, the example request de-bundler 402, the example transmitter 404, and/or more generally, the example MA-USB device PAL 216 of FIG. 4, could be implemented by analog and/or digital circuit(s), logic circuit(s), programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example receiver 300, the example data determiner 302, the example request bundler 304, the example transmitter 306 and/or, more generally, the example MA-USB host PAL 214 of FIG. 3, and/or the example receiver 400, the example request de-bundler 402, the example transmitter 404, and/or more generally, the example MA-USB device PAL 216 of FIG. 4, is/are hereby expressly defined to include a tangible computer readable storage device or storage disk such as a memory, a digital versatile disk (DVD), a compact disk (CD), a Blu-ray disk, etc. storing the software and/or firmware. Further still, the example MA-USB host PAL 214 of FIG. 3 and/or the example MA-USB device PAL 216 of FIG. 4 includes elements, processes and/or devices in addition to, or instead of, those illustrated in FIGS. 5 and 6, and/or may include more than one of any or all of the illustrated elements, processes and devices.

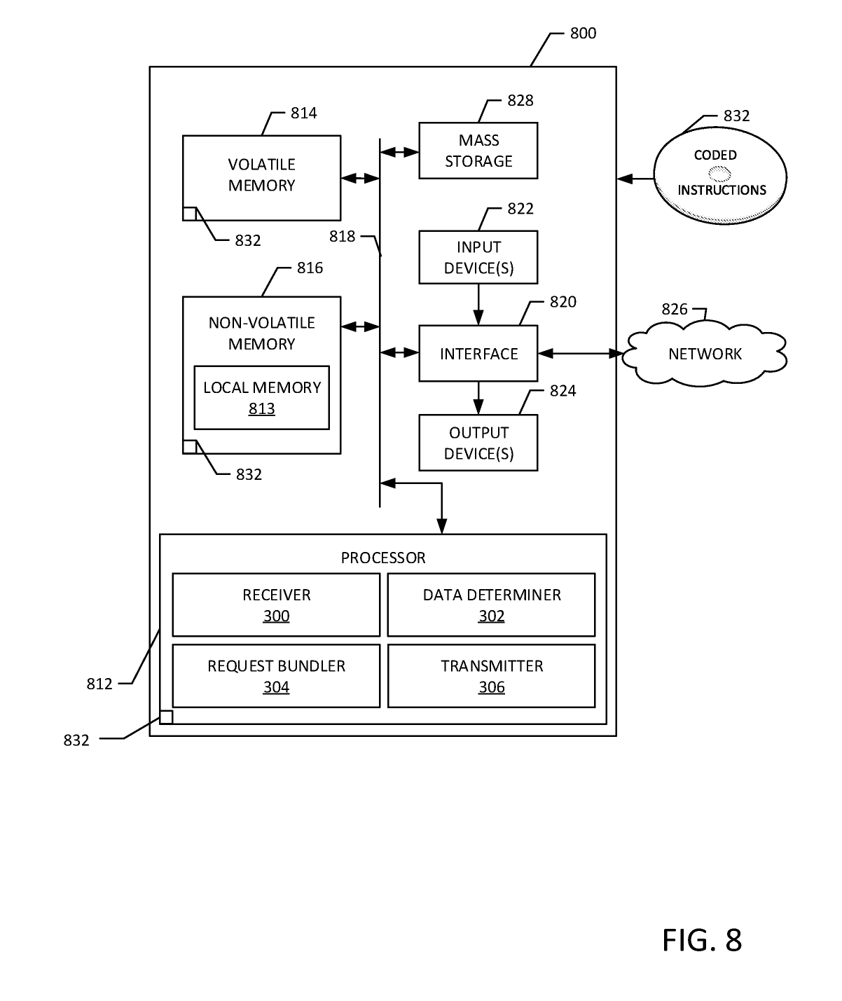

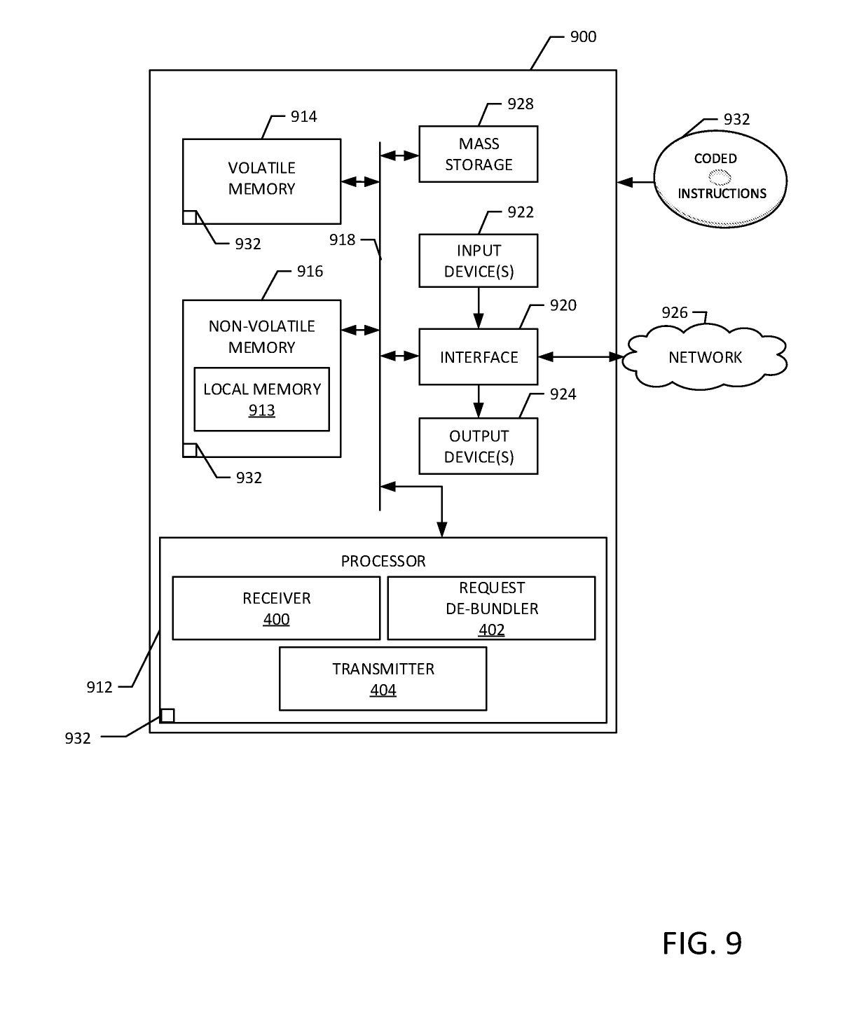

A flowchart representative of example machine readable instructions for implementing the example MA-USB host PAL 214 of FIG. 3 is shown in FIG. 5 and the example MA-USB device PAL 216 of FIG. 4 is shown in FIG. 6. In the examples, the machine readable instructions comprise a program for execution by a processor such as the processors 812, 912 shown in the example processor platforms 800, 900 discussed below in connection with FIGS. 8 and 9. The program may be embodied in machine readable instructions stored on a tangible computer readable storage medium such as a CD-ROM, a floppy disk, a hard drive, a digital versatile disk (DVD), a Blu-ray disk, or a memory associated with the processors 812, 912, but the entire program and/or parts thereof could alternatively be executed by a device other than the processors 812, 912 and/or embodied in firmware or dedicated hardware. Further, although the example program is described with reference to the flowcharts illustrated in FIGS. 5 and 6, many other methods of implementing the example MA-USB host PAL 214 of FIG. 3 and/or the example MA-USB device PAL 216 of FIG. 4 may alternatively be used. For example, the order of execution of the blocks may be changed, and/or some of the blocks described may be changed, eliminated, or combined.

As mentioned above, the example processes of FIGS. 5 and 6 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 5 and 6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 5 is an example flowchart 500 representative of example machine readable instructions that may be executed by the example MA-USB host PAL 214 to facilitate communications between the example USB device driver 202 and the example MA-USB device 206.

At block 502, the example receiver 300 receives a transmission from the example USB device driver 202. As described above, the transmission corresponds to an operation to be performed by the example MA-USB endpoint 208. For example, the transmission may correspond to an abort operation, a suspend operation, and/or any other state change operation. At block 504, the example data determiner 302 determines data from the received transmission. The example data determiner 302 determines which operation is to be performed by the example MA-USB endpoint 208 based on the received transmission. Additionally, the example data determiner 302 determines which requests (e.g., activate, clear transfers, inactivate) correspond to the determined operation.

At block 506, the example request bundler 304 determines if the data associated with the received transmission includes more than one request. As described above, the operation associated with the received transmission may include any number of requests. Additionally, the example request bundler 304 may include identifiers and/or an order in the bundle. If the example request bundler 304 determines that the data associated with the received transmission includes more than one request, the example request bundler 304 bundles the requests into a single transmission request (block 508). If the example request bundler 304 determines that the data associated with the received transmission does not include more than one request (e.g., the data includes one request), the instruction continues to block 510.

At block 510, the example transmitter 306 transmits the request bundle or the request (e.g., via a MAC layer) to the example MA-USB device 206. At block 512, the example receiver 300 determines if a bundle response has been received from the example MA-USB 206. As further described in FIG. 6, once the example MA-USB device 206 transmits commands associated with the requests to the example MA-USB endpoint 208, the example MA-USB device 206 transmits a response (e.g., a bundle response) to the example MA USB host 204 to verify that the bundle of requests have been transmitted to and/or executed by the example MA-USB endpoint 208. As described above, poor link conditions may lead to packet loss (e.g., the request bundle not reaching the example MA-USB device 206). Thus, the example transmitter 306 may re-transmit the request or request bundle after a preset amount of timeout (e.g., delay) (e.g., 5 milliseconds). If the response has not been received by the example receiver 300, the example transmitter 306 repeats the transmission of the request or the request bundle to the example MA-USB device 206.

Once the example receiver 300 receives a response (e.g., via a MAC layer) from the example MA-USB device 206, the example transmitter 306 transmits a response transmission (e.g., via the MAC layer) to the USB device driver 202 (block 514). As described above, the response transmission indicates (e.g., verifies) that the operation associated with the received transmission has been executed by the example MA-USB endpoint 208.

FIG. 6 is an example flowchart 600 representative of example machine readable instructions that may be executed by the example MA-USB device PAL 216 to facilitate communications between the example MA-USB host 204 and the example MA-USB endpoint 208.

At block 602, the example receiver 400 receives a transmission (e.g., via a MAC layer) from the example MA-USB host 204. As described above, the received transmission is a command or a bundle of requests sent as a single bundle request. At block 604, the example request de-bundler 402 processes the received transmission. For example, the example request de-bundler 402 determines whether the received transmission is a request or a bundle of requests. In some examples, the request de-bundler 402 may determine any identifiers in the request or bundle of requests.

At block 606, the example request de-bundler 402 determines if the received transmission includes more than one request. If the received transmission does not include more than one request (e.g., the received transmission includes one request), the instructions continue to block 612. If the received transmission does include more than one request (e.g., the received transmission is a bundled request), the example request de-bundler 402 de-bundles the bundled requests (block 608) by separating the bundled requests into individual requests. At block 610, the example request de-bundler 402 orders the de-bundled requests. In some examples, the request de-bundler 402 orders the de-bundle request based on an order included in the received transmission. In some examples, the request de-bundler 402 orders the request based on a hierarchy of requests.

At block 612, the example transmitter 404 transmits a first command associated with the first request to the example MA-USB endpoint 208. In some examples, the first command corresponds to a response. In such examples, the first command is transmitted to the example MA-USB endpoint 208 and a preceding command may not be transmitted until the response corresponding to the first command. At block 614, the example request de-bundler 402 determines if the first command requires a response. If the request de-bundler 402 determines that the first command does require a response, the instructions continue to block 616. If the request de-bundler 402 determines that the first command does not require a response, the instructions continue to block 618.

At block 616, the example receiver 400 determines if a response has been received. If the example receiver 400 does not receive a response corresponding to the first command, the example transmitter 404 transmits the first command again after a preset amount of timeout (e.g., delay) (e.g., 5 milliseconds). If the example receiver 400 does receive the response corresponding to the first command, the example request de-bundler 402 determines if there is an additional command associated with an additional request to transmit to the example MA-USB endpoint 208 (block 618). If the request de-bundler 402 determines that there is an additional (e.g., second, third, etc.) command, the example transmitter 404 transmits the additional command to the example MA-USB endpoint 208. The instructions continue until all of the commands associated with the request bundle have been executed. If the example request de-bundler 402 determines that there is not an additional command, the example transmitter 404 transmits a bundle response transmission (e.g., via a MAC layer) to the MA-USB host 204 (block 620). As previously described, the response transmission indicates that the commands have been transmitted to and/or executed by the example MA-USB endpoint 208.

FIG. 7 is a timing diagram that illustrates an example of the communications between the example USB device driver 202, the example MA-USB host 204, the example MA-USB device 206, and the example MA-USB endpoint 208 to perform a suspend device operation. As described above, the suspend device operation includes an abort operation followed by a suspend operation. Alternatively, any operation with any number of requests may be performed. The illustrated timing diagram of FIG. 7 includes the example USB device driver 202, the example MA-USB host 204, the example MA-USB device 206, and the example MA-USB endpoint 208 of FIG. 2. The illustrated timing diagram of FIG. 7 further includes an example abort endpoint transmission 700, an example endpoint bundle request 702, an example stop endpoint command 704, an example stop endpoint response 706, an example remove transfers command 708, an example start endpoint command 710, an example endpoint bundle response 712, an example abort endpoint response 714, an example suspend endpoint transmission 716, an example endpoint inactivate request for suspend 718, an example stop endpoint command 720, an example endpoint response 722, an example endpoint inactivate response for suspend 724, an example suspend complete transmission 726, an example abort duration 728, and an example suspend duration 730.

The illustrated timing diagram of FIG. 7 starts when the USB device driver 202 transmits the example abort endpoint transmission 700 to the example MA-USB host 204. Once the MA-USB host 204 receives the example abort endpoint transmission 700, the example MA-USB host 204 determines that the abort endpoint transmission 700 is associated with an abort operation. The example MA-USB host 204 generates bundle including requests (e.g., an endpoint inactivate request, and a clear transfers request, and an endpoint activate request) associated with the abort operation (e.g., the example endpoint bundle request 702). The example MA-USB 204 transmits the example endpoint bundle request 702 (e.g., via a MAC layer) to the example MA-USB device 206.

Once the example MA-USB device 206 receives the example endpoint bundle request 702, the example MA-USB device 206 de-bundles the bundle to obtain the requests. The MA-USB device 206 orders the requests. As described above, the MA-USB device 206 may order the requests based on a hierarchy and/or an order included in the example endpoint bundle request 702. In the illustrated example, an endpoint inactivate request is first, an endpoint clear transfers request is second, and an endpoint activate request is third. The endpoint inactivate request corresponds to the example stop endpoint command 704, the endpoint clear transfers request corresponds to the example move transfers command 708, and the endpoint activate corresponds to the example start endpoint command 710. The example MA-USB device 206 transmits the example stop endpoint command 704 to the example MA-USB endpoint 208. In the illustrated example, the example stop endpoint command 704 is associated with the example stop endpoint response 706. Thus, the example MA-USB device 206 may not send the second command (e.g., the example remove transfers command 708) until the example stop endpoint response 706 is received. Once the example stop endpoint response 706 is received by the example MA-USB device 206, the MA-USB device 206 transmits the example remove transfers command 708. After the example MA-USB device 206 transmits the example remove transfers command 708 to the MA-USB endpoint 208, the MA-USB device 206 transmits a start endpoint command 710 to the MA-USB endpoint 208.

Once all of the commands associated with the example endpoint bundle request 702 have been transmitted to and/or executed by the example MA-USB endpoint 208, the example MA-USB device 206 transmits the example endpoint bundle response 712 to the example MA-USB host 204 (e.g., via a MAC layer). As described above, the example endpoint bundle response 712 indicates that the commands associated with the operation have been executed. Once the MA-USB host 204 receives the endpoint bundle response 712, the MA-USB host 204 transmits the example abort endpoint response 714 to the example USB device driver 202 indicating that the abort operation has been executed.

Once the example USB device driver 202 receives the example abort endpoint response 714, the USB device driver 202 transmits the example suspend endpoint transmission 716 to the example MA-USB host 204. The example MA-USB host 204 receives the example suspend endpoint transmission 716 and determines that the suspend endpoint transmission 716 is associated with a suspend operation. The MA-USB host 204 transmits the example endpoint inactivate request 718 to the example MA-USB device 206 (e.g., via a MAC layer) to suspend the MA-USB endpoint 208.

The example MA-USB device 206 receives the example endpoint inactivate request 718 and determines that the request does not need to be de-bundled. The example endpoint inactivate request 718 corresponds to the example stop endpoint command 720. The example MA-USB device 206 transmits the example stop endpoint command 720 to the example MA-USB endpoint 208 to suspend the MA-USB endpoint 208. Once the example MA-USB device 206 receives the example stop endpoint response 722 (e.g., indicating that the stop endpoint command 720 was received/executed by the MA-USB endpoint 208), the MA-USB device 206 transmits the example endpoint inactivate response 724 to the example MA-USB host 204 (e.g., via the MAC layer). As described above, the example endpoint inactivate response 724 indicates that the MA-USB endpoint 208 has been suspended. Once the example MA-USB host 204 receives the example endpoint inactivate respond 724, the MA-USB host 204 transmits the example suspend complete transmission 726.

In the illustrated example of FIG. 7, the example abort duration 728 corresponds to a duration of time between when the example abort endpoint 700 is output by the example USB device driver 202 and when the example abort endpoint response 714 is received by the USB device driver 202. The duration of time to transmit a transmission between the example USB device driver 202 and the example MA-USB host 204 or between the example MA-USB device 206 and the example MA-USB endpoint 208 is inconsequential compared to the duration of time to transmit a transmission between the example MA-USB host 204 and the example MA-USB device 206. Thus, the example abort duration 728 is measured by factors of RTT. As described above, RTT is the amount of time between when the MA-USB host 204 transmits a request and when the MA-USB host 204 receives a response to the request. The illustrated example of FIG. 7 includes one endpoint bundle request/response between the example abort endpoint 700 and the abort endpoint response 714. Thus, the example abort duration 728 is 1×RTT. The example suspend duration 730 corresponds to a duration of time between when the example abort endpoint is output by the example USB device driver 202 and when the example suspend complete transmission 726 is received by the USB device driver 202. The illustrated example of FIG. 7 includes one endpoint bundle request/response and one endpoint inactivate request/response between the example abort endpoint 700 and the example suspend complete transmission 726. Thus, the example suspend duration 730 is 2×RTT.

The illustrated example of FIG. 7 is an example suspend operation between the example USB device driver 202 and the example MA-USB endpoint 208 in good link conditions. However, in some examples, the suspend operation may be operated under poor link conditions where bundles may be lost. In such examples, the MA-USB host 204 may transmit a bundle and/or a request to the MA-USB device 206 that is lost in transmission. To overcome lost bundles, the example MA-USB host 204 may weight a predetermined amount of time (e.g., RTT+5 ms) before the MA-USB host 204 retransmits the bundle. In such examples, the example abort duration 728 and/or suspend duration 730 may be longer due to the lost bundle. For example, if there is one bundle lost during the example abort duration 728, the abort duration 728 will be 2×RTT+5 ms (e.g., 1×RTT for the successful transmission and 1×RTT+5 ms for the lost transmission).

FIG. 8 is a block diagram of an example processor platform 800 capable of executing the instructions of FIG. 5 to implement the example MA-USB host PAL 214 of FIGS. 2 and 3. The processor platform 800 can be, for example, a server, a personal computer, a mobile device (e.g., a cell phone, a smart phone, a tablet such as an iPad™), a personal digital assistant (PDA), an Internet appliance, or any other type of computing device.

The processor platform 800 of the illustrated example includes a processor 812. The processor 812 of the illustrated example is hardware. For example, the processor 812 can be implemented by integrated circuits, logic circuits, microprocessors or controllers from any desired family or manufacturer.

The processor 812 of the illustrated example includes a local memory 813 (e.g., a cache). The example processor 812 of FIG. 8 executes the instructions of FIG. 5 to implement the example receiver 300, the example data determiner 302, the example request bundler 304, and/or the example transmitter 306 of FIG. 3 to implement the example MA-USB host PAL 214. The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a clock controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, one or more input devices 822 are connected to the interface circuit 820. The input device(s) 822 permit(s) a user to enter data and commands into the processor 812. The input device(s) can be implemented by, for example, a sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 820 of the illustrated example, thus, typically includes a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes one or more mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The coded instructions 832 of FIG. 8 may be stored in the mass storage device 828, in the volatile memory 814, in the non-volatile memory 816, and/or on a removable tangible computer readable storage medium such as a CD or DVD.

FIG. 9 is a block diagram of an example processor platform 900 capable of executing the instructions of FIG. 6 to implement the example MA-USB device PAL 216 of FIGS. 2 and 4. The processor platform 900 can be, for example, a server, a personal computer, a mobile device (e.g., a cell phone, a smart phone, a tablet such as an iPad™), a personal digital assistant (PDA), an Internet appliance, or any other type of computing device.

The processor platform 900 of the illustrated example includes a processor 912. The processor 912 of the illustrated example is hardware. For example, the processor 912 can be implemented by integrated circuits, logic circuits, microprocessors or controllers from any desired family or manufacturer.

The processor 912 of the illustrated example includes a local memory 913 (e.g., a cache). The example processor 912 of FIG. 9 executes the instructions of FIG. 6 to implement the example receiver 400, the example request de-bundler 402, and/or the example transmitter 404 of FIG. 4 to implement the example MA-USB device PAL 216. The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a clock controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, a sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives.

The coded instructions 932 of FIG. 9 may be stored in the mass storage device 928, in the volatile memory 914, in the non-volatile memory 916, and/or on a removable tangible computer readable storage medium such as a CD or DVD.

From the foregoing, it would be appreciated that the above disclosed method, apparatus, and articles of manufacture facilitate MA-USB communications between a MA-USB host and a MA-USB device. Using the examples disclosed herein, an MA-USB host can bundle a plurality of sequential requests into a single bundle transmission. In such examples, the MA-USB host can wirelessly transmit the bundle of requests in the single bundle transmission to a MS-USB device. The MS-USB device de-bundles the requests and sequentially transmits commands associated with the requests to an MA-USB endpoint.

Conventional techniques for wirelessly transmitting MA-USB requests include sending each of the requests separately. Such conventional techniques create additional latency that causes additional power consumption and slower performance. Examples disclosed herein alleviate such problems by bundling the USB requests to significantly decrease the latency associated with conventional techniques.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Example 1 is a method comprising receiving a transmission from a USB device driver, determining a plurality of requests associated with the received transmission, bundling the plurality of requests into a single request, and transmitting the single request to a USB device.

Example 2 includes the subject matter of example 1, wherein the received transmission corresponds to an operation, the operation being performed by the second USB device after the USB device receives the request.

Example 3 includes the subject matter of example 1, wherein the USB device is a Media Agnostic USB device.

Example 4 includes the subject matter of example 1, wherein the single request includes an execution order of the plurality of requests.

Example 5 includes the subject matter of example 1, wherein the single request is transmitted wirelessly.

Example 6 includes the subject matter of example 1, 2, 3, 4, or 5, further including receiving a first response associated with the single request from the USB device. Example 6 further includes transmitting a second response associated with the received transmission to the USB device driver.

Example 7 includes the subject matter of example 6, wherein the first response is received wirelessly.

Example 8 is an apparatus comprising a receiver to receive a transmission from a Universal Serial Bus (USB) device driver, a data determiner to determine a plurality of requests associated with the received transmission, a request bundler to bundle the plurality of requests into a single request, and a transmitter to transmit the single request to a USB device.

Example 9 includes the subject matter of example 8, wherein the received transmission corresponds to an operation to be performed by the USB device.

Example 10 includes the subject matter of example 8, wherein the USB device is a Media Agnostic USB device.

Example 11 includes the subject matter of example 8, wherein the single request includes an execution order of the plurality of requests.

Example 12 includes the subject matter of example 8, wherein the transmitter is to transmit the single request wirelessly.

Example 13 includes the subject matter of example 8, 9, 10, 11, or 12, wherein the receiver is to receive a first response associated with the single request from the USB device and the transmitter is to transmit a second response associated with the received transmission to the USB device driver.

Example 14 includes the subject matter of example 13, wherein the receiver is to receive the first response wirelessly.

Example 15 is a computer readable medium comprising instructions that, when executed, case a machine to receive a transmission from a USB device driver, determine a plurality of requests associated with the received transmission, bundle the plurality of requests into a single request, and transmit the single request to a USB device.

Example 16 includes the subject matter of example 15, wherein the received transmission corresponds to an operation to be performed by the USB device.

Example 17 includes the subject matter of example 15, wherein the USB device is a Media Agnostic USB device.

Example 18 includes the subject matter of example 15, wherein the single request includes an execution order of the plurality of requests.

Example 19 includes the subject matter of example 15, wherein the instructions cause the machine to transmit the single request wirelessly.

Example 20 includes the subject matter of example 15, 16, 17, 18, or 19, wherein the instructions cause the machine to receive a first response associated with the single request from the USB device and transmit a second response associated with the received transmission to the USB device driver.

Example 21 includes the subject matter of example 20, wherein the instructions cause the machine to receive the first response wirelessly.

Example 22 is a system comprising a USB host to receive a transmission from a USB device driver, determine a plurality of requests associated with the received transmission, generate a bundle request including the plurality of requests, and transmit the bundle request to a USB device. Example 22 further comprises the USB device to receive the bundle request from the USB host, de-bundle the bundle request to identify the plurality of requests, and transmit a plurality of commands to a USB endpoint, each of the plurality of commands corresponding to one of the plurality of requests.

Example 23 includes the subject matter of example 22, wherein the USB host and the USB device are wirelessly connected.

Example 24 includes the subject matter of example 22 or 23, wherein the USB device is to, in response to transmitting the plurality of commands to the USB endpoint, transmit a first response associated with the bundle request to the USB host.

Example 25 includes the subject matter of example 24, wherein the USB host is to receive the first response from the USB device, and in response to receiving the first response, transmit a second response associated with the received transmission to the USB device driver.

Example 26 includes the subject matter of example 25, wherein the USB device is a Media Agnostic USB device and the USB host is a Media Agnostic USB host.

Example 27 includes the subject matter of example 23, wherein the USB device is to determine an execution order of the plurality of requests.

Example 28 includes the subject matter of example 27, wherein the USB device driver is to include the execution order in the bundle request, the USB device to determine the execution order after receiving the bundle request.

Example 29 includes the subject matter of example 27 of 28, wherein the execution order is based on a hierarchy.

Example 30 includes the subject matter of example 27, 28, or 29, wherein the USB device is to transmit the plurality of commands based on the execution order.

Example 31 includes an apparatus comprising a receiver to receive a single request from a USB host, the single request including a plurality of requests, a request de-bundler to de-bundle the single request to identify the plurality of requests, and a transmitter to transmit a plurality of commands to a USB endpoint, each of the plurality of commands corresponding to one of the plurality of requests.

Example 32 includes the subject matter of example 31, wherein the request de-bundler is to determine an execution order of the plurality of requests.

Example 33 includes the subject matter of example 32, wherein the transmitter is to the transmit the plurality of commands by:

transmitting a first command corresponding to a first request of the plurality of requests to the USB endpoint; and

transmitting a second command corresponding to a second request of the plurality of requests to the USB endpoint, the first command preceding the second command in the execution order of the plurality of requests.

Example 34 includes the subject matter of example 33, wherein the transmitter is to transmit the second command in response to receiving a response to the first command.

Example 35 includes the subject matter of example 32, wherein the execution order of the plurality of requests is determined based on a hierarchy.

Example 36 includes the subject matter of example 32, wherein the bundle request includes data associated with the execution order of the plurality of requests.

Example 37 includes the subject matter of example 31, wherein the receiver is to receive the bundle request wirelessly.

Example 38 includes the subject matter of example 31, wherein the transmitter is to transmit a first response associated with the bundle request to the USB host.

Example 39 includes the subject matter of example 38, wherein the transmitter is to transmit the first response wirelessly.

The apparatus of claim 31, 36, or 39, wherein the USB host is a Media Agnostic USB host and the USB endpoint is a Media Agnostic USB endpoint.

What is claimed is:

1. A method comprising:
receiving a transmission from a Universal Serial Bus (USB) device driver;
determining a plurality of requests associated with the received transmission;
bundling the plurality of requests into a single request; and
transmitting the single request to a USB device.

2. The method of claim 1, wherein the received transmission corresponds to an operation to be performed by the USB device.

3. The method of claim 1, wherein the USB device is a Media Agnostic USB device.

4. The method of claim 1, wherein the single request includes an execution order of the plurality of requests.

5. The method of claim 1, wherein the single request is transmitted wirelessly.

6. The method of claim 1, further including:
receiving a first response associated with the single request from the USB device; and
transmitting a second response associated with the received transmission to the USB device driver.

7. The method of claim 6, wherein the first response is received wirelessly.

8. An apparatus comprising:
a receiver to receive a transmission from a Universal Serial Bus (USB) device driver;
a data determiner to determine a plurality of requests associated with the received transmission;
a request bundler to bundle the plurality of requests into a single request; and
a transmitter to transmit the single request to a USB device.

9. The apparatus of claim 8, wherein the received transmission corresponds to an operation to be performed by the USB device.

10. The apparatus of claim 8, wherein the USB device is a Media Agnostic USB device.

11. The apparatus of claim 8, wherein the single request includes an execution order of the plurality of requests.

12. The apparatus of claim 8, wherein the transmitter is to transmit the single request wirelessly.

13. The apparatus of claim 8, wherein:
the receiver is to receive a first response associated with the single request from the USB device; and
the transmitter is to transmit a second response associated with the received transmission to the USB device driver.

14. The apparatus of claim 13, wherein the receiver is to receive the first response wirelessly.

15. A computer readable medium comprising instructions that, when executed, case a machine to:
receive a transmission from a Universal Serial Bus (USB) device driver;
determine a plurality of requests associated with the received transmission;
bundle the plurality of requests into a single request; and
transmit the single request to a USB device.

16. The computer readable medium of claim 15, wherein the received transmission corresponds to an operation to be performed by the USB device.

17. An apparatus comprising:
a receiver to receive a single request from a USB host, the single request including a plurality of requests;
a request de-bundler to de-bundle the single request to identify the plurality of requests; and
a transmitter to transmit a plurality of commands to a USB endpoint, each of the plurality of commands corresponding to one of the plurality of requests.

18. The apparatus of claim 17, wherein the request de-bundler is to determine an execution order of the plurality of requests.

19. The apparatus of claim 18, wherein the transmitter is to the transmit the plurality of commands by:
transmitting a first command corresponding to a first request of the plurality of requests to the USB endpoint; and
transmitting a second command corresponding to a second request of the plurality of requests to the USB endpoint, the first command preceding the second command in the execution order of the plurality of requests.

20. The apparatus of claim 19, wherein the transmitter is to transmit the second command in response to receiving a response to the first command.
